(19) United States
(12) Patent Application Publication
(10) Pub. No.: US 2023/0040228 A1
(43) Pub. Date: Feb. 9, 2023

(54) OVERLAPPING CANINES AND LATERALS DENTITION APPLIANCE

(71) Applicant: ORTHO-TAIN, INC., Toa Alta (PR)

(72) Inventor: Earl O. Bergersen, Glenview, IL (US)

(21) Appl. No.: 17/392,427

(22) Filed: Aug. 3, 2021

(51) Int. Cl. A61C 7/08

(52) U.S. Cl. CPC A61C 7/08

(57) ABSTRACT

A preformed dentition appliance to adjust an alignment of a person's teeth. The preformed dentition appliance includes a body having a front portion and a rear portion extending from the front portion. The body defines a central longitudinal axis extending from the front portion to the rear portion and includes a trough disposed between an outer shield spaced from an inner shield. The outer shield and the inner shield are each inclined with respect to the trough. A first protrusion extends laterally along a distal surface of the outer shield directed toward a second protrusion that extends laterally along a mesial surface of the inner shield. The first and second protrusions include one or more terminating ends located toward a distal side of a lateral incisor tooth and a mesial side of a canine tooth to adjust the alignment thereof to accommodate anterior crowding of upper and/or lower teeth.

### TECHNICAL FIELD

The present disclosure relates to a method and appliance for aligning the teeth of children, adolescents, and young adults, and more particularly relates to an appliance to reduce incisal crowding by overlapping of incisal and canine teeth.

### BACKGROUND OF THE DISCLOSURE

The statements in this section merely provide background information related to the present disclosure and should not be construed as constituting prior art.

The correction of teeth crowding at the time the permanent lower and upper anterior teeth (the incisors and canines) erupt is problematic since there is no space available at this age, and intensifies as the child gets older (typically 12 years and older). Several orthodontic techniques are used to solve this rather common problem. Lower teeth often have more crowding than upper teeth and anterior teeth are more crowded than posterior teeth. Also, the lower teeth are surrounded by cortical bone, while the uppers are surrounded by cancellous bone. Cortical bone is not so easily altered as cancellous bone and restricts tooth movement. To gain extra space in the lower arch is rather restrictive once all of the permanent teeth have fully erupted since the spaces that were present in the mixed dentition have all been closed with the eruption of the lower 2nd permanent molars at 12 years of age.

A number of options are available to correct this crowding, which in turn, enables improved tooth alignment, requires directing the teeth to a preferred location as they erupt or extracting one or more teeth to provide room for the teeth as they erupt. The options available include: 1) distalizing the lower posterior teeth with a bumper or sagittal appliance; 2) extraction of 2 bicuspids one on each side of lower arch (and or upper arch); 3) stripping the enamel on the mesial and distal of the anterior teeth; 4) squeezing the teeth into alignment without creating the needed space; 5) expanding the lower or upper arch; and 6) overlapping the laterals and canines.

Items 3, 4, 5, as recited above, are generally contraindicated due to the strong tendency for relapse (especially in the lower arch), potential damage to the protective enamel of the lower anteriors that can increase the risk of decay, and lowering of the gingival and bony support of the teeth.

The use of bumpers and sagittal appliances can be quite successful but are troublesome to use and require more expertise to be used properly by a patient. Extraction is only used for severe crowding, while overlapping of canines and laterals have several advantages. One is that it allows for future crowding to be accommodated, which almost always occurs with increase in age. Any additional crowding is absorbed into the overlapping (where the sides of adjacent teeth are overlapped) by increasing the overlapping without any crowding of the incisal area. There is no removal of enamel as is done in stripping and the full enamel protection against future decay is preserved as well as the integrity of the interproximal bone support. Also, stripping has a strong tendency for future increase in crowding of the incisors. Also, often there is a tendency already in existence for the overlapping of one or both sides and the procedure can just be continued in the direction of the overlap. In some appliances, metal cleats have to be hand placed in the proper position to create the rotations with the removal of the interproximal rib between the canine and lateral in the appliance to allow for the overlap to take place.

This overlapping can occur in two different ways—one is where the canine is rotated to the labial of the lateral and the other alternative is where the canine is rotated to the lingual of the lateral. Periodically the overlapping present on one side is in one way and the other side is rotated the other way.

What is needed, therefore, is a preformed appliance that requires either no adjustment or a small adjustment to provide some amount of overlapping, while straightening the other teeth.

### SUMMARY OF THE DISCLOSURE

In one embodiment, there is provided a preformed dentition appliance to adjust an alignment of a person's teeth including a body having a front portion and a rear portion extending from the front portion. The body defines a central longitudinal axis extending from the front portion to the rear portion, a trough, and an outer shield spaced from an inner shield with the trough disposed therebetween. The outer shield is higher in the upper and lower arches to prevent mouth breathing and the body includes straps extending from the outer shield and the inner shield to the labial and lingual surfaces of the front teeth to rotate the teeth and to overlap the canine and lateral in different directions to accommodate adult incisal crowding, if needed.

In another embodiment, there is provided a method of fitting a preformed dentition appliance to adjust an alignment of a person's teeth. The method includes: determining a size of one of a person's upper arch or lower arch; selecting from two or more preformed dentition appliances, each of which includes a labial bar extending from a labial shield and a lingual bar extending from a lingual shield, based on the determined size of the person's upper arch or lower arch; and configuring one or both of the lingual bar or labial bar to rotate one or both of a person's canines or laterals to adjust the alignment of the person's teeth for incisal crowding.

In one or more embodiments, the present disclosure describes one or more appliances, devices, and methods having one or more of the following features. Appliances having these features include, but are not limited to: 1) an appliance with a preformed slat or bar to treat rotations; 2) an appliance in which rotation slats or bars effectively adjust many different sizes of teeth; 3) an appliance in which rotation of slats or bars present on the lingual and labial surfaces of the teeth provide tooth rotation in any different direction; 4) an appliance that rotates canines and laterals, both upper and/or lower, to overlap canines and laterals in either direction, i.e. canine to labial or canine to lingual of lateral, to accommodate anterior crowding; 5) an appliance that includes a rotation slat or bar on the distal of the lateral and the mesial of canine that can be removed if not needed; 6) an appliance that speeds up the rotations of teeth for alignment; 7) an appliance that includes individual projections of one or several bars across the labial and lingual of the teeth 8) an appliance that is either preformed or custom made; 9) a single appliance or multiple sizes of appliance to provide tooth alignment for different sizes of arches; 10) an appliance including an opening for a connection rod for connection to a pulsation device; 11) an appliance that includes an embedded wire to widen or constrict an arch (upper or lower jaw); 12) an appliance that includes extended shields to reduce or stop mouth breathing; 13) an appliance including extended lower lingual tabs to hold the mandible forward while sleeping thereby preventing collapse of the oropharynx and to advance the mandible; 14) an appliance including higher posterior margins to better retain reline material to the interproximal areas; and 15) a single preformed appliance with or without sockets configured to fit several sizes of teeth and arches.

### BRIEF DESCRIPTION OF THE DRAWINGS

The above-mentioned aspects of the present application and the manner of obtaining them will become more apparent and the teachings of the present application itself will be better understood by reference to the following description of the embodiments of the present application taken in conjunction with the accompanying drawings, wherein:

FIG. 1A is a perspective top view of overlapping canines and laterals dentition appliance for an upper (maxillary) arch of an individual;

FIG. 1B a perspective top view of another embodiment overlapping canines and laterals dentition appliance for an upper (maxillary) arch of an individual;

FIG. 2 is a view of the teeth of an upper arch illustrating labial bars and distal bars located at the anterior teeth;

FIG. 3 is a bottom view of one embodiment of overlapping canines and laterals dentition appliance for a lower (mandibular) arch of an individual;

FIG. 4 is a bottom view of one embodiment of overlapping canines and laterals dentition appliance for a lower (mandibular) arch of an individual;

FIG. 5 is a front view of an incisal bar located at the incisors of the lower arch;

FIG. 6 illustrates a labial incisal strap located at bottom incisors;

FIG. 7 illustrates a portion of dentition appliance for both the upper arch and the lower arch having a cutaway view to show locations of a labial bar and a lingual bar; and

FIG. 8 illustrates a side view of a portion of a dentition appliance for overbite correction.

### DETAILED DESCRIPTION

While exemplary embodiments incorporating the principles of the present disclosure have been disclosed herein, the present disclosure is not limited to the disclosed embodiments. Instead, this application is intended to cover any variations, uses, or adaptations of the disclosure using its general principles. Further, this application is intended to cover such departures from the present disclosure as come within known or customary practice in the art to which this invention pertains.

The present inventor has previously developed a preformed adult dentition appliance that is available in 13 different sizes. Please see U.S. Pat. Nos. 4,799,884, 5,645,420, 5,876,199, 6,676,664, 7,963,765, 7,458,810, 8,133,050, 8,870,566, and 9,393,083, each of which is incorporated herein by reference in its entirety. These appliance sizes vary by 0.8 mm for the lower incisor sizes for each half size difference of the 4 lower permanent incisors. This means that a different appliance is used when the distance from a first side of a first incisor to the last side of the last incisor changes by 0.8 mm. Each half size of an appliance is varied from one size to the next by a half size such that the change between adjacent half sizes is gradual. As the individual matures and more teeth erupt, the width of a shield and a trough of the appliance varies based on the sizes of the dentition. For instance, in the inventor's appliances identified as the G series, the C series, or the N series, the 0.8 mm refers to a half size difference of the 4 lower incisors from e.g. 4G, 4C or 4N to 4.5G, 4.5C or 4.5N. These increased sizes each vary by an increase of 0.8 mm for the 4 lower permanent incisors.

As described herein, in one or more embodiments, a preformed appliance is designed to fit several sizes in a series identified as the N series, including 13 different sizes. For instance, in one embodiment, a preformed appliance is designed to fit about 3 half sizes or more increments of the N series within a single appliance. In one embodiment, a middle sized appliance over a range of three adjacent half sizes is selected to use to correct overlapping canines and laterals. In the known, G, C, and N series, each half size is very gradually altered from the next size above (or below). The major difference are the 2 sizes as described above. The shield and trough width and length varies according to the sizes of the dentition. With the 3 different sizes averaged, the middle sized appliance is used. The variations of the other 2 above and below the middle ones are very minor except for the tooth widths. For example, since the teeth are very small for an individual who might be fitted for sizes 1 and 1.5N, such sizes would rarely be used, since the teeth of such individuals are also not often crowded. As a result, a preformed appliance is made to fit 3 or 4 different sizes at the same time or a single size accommodate all 12 or 13 sizes at the same time. Consequently, in one embodiment, the preformed appliance includes one size of appliance to fit individuals experiencing overlapping of anterior teeth that produces misaligned teeth. In other embodiments, two or more preformed appliances are provided to fit individuals of having arches of different sizes.

In at least one embodiment, a single size is designed to resemble the 4.5N which fits the 1N, 1.5N, 2N, 2.5N, 3N, 3.5N, and 4N in one direction, which in the other direction it would accommodate 7 sizes from 4.5N up through 7.5N. Both sides vary by 4.8 mm (0.8×6=4.8 mm) which would be 2.4 mm per side. This value, 4.8 mm refers to the width of the 4 lower incisors. This represents a convenient method of design however, any combination when being represented by more than one preformed appliance could be a better fit and be more comfortable to the patient. The single appliance could be designed using a 4.5N. This appliance size would proceed in both directions with half across the canine crown, the appliance would be wider in a distal direction in order to accommodate the premolar size of both the 1N and 7.5N. While one size of appliance is possible to correct the overlapping canines and laterals, it is not preferred in some cases because of the large differences of lower incisor widths as well as the widths of the other teeth.

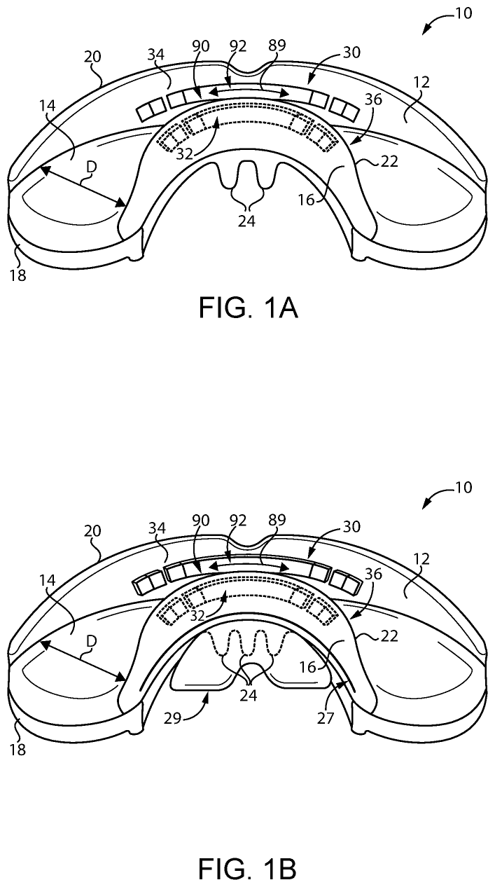

FIG. 1A is a perspective top view of an overlapping canines and laterals dentition appliance 10 for an upper arch of an individual. In the illustrated embodiment, the appliance 10 includes an upper outer shield 12, also identified as a labial shield. In one embodiment, the appliance 10 is provided as a single sized appliance configured as one size fits most to fit a range of patients. In other embodiments, the appliance is provided in different sizes to fit different sizes of mouths and arches and engages both the upper teeth and the lower teeth. The high upper outer shield 12 extends upwardly from a trough 14 that is configured to fit the upper teeth, such that the upper teeth are bordered by the outer shield 12, the trough 14, and an inner shield 16. At a rear upper portion 18 of the appliance 10, a lateral distance “D” of the trough, between the outer shield 12 and the inner shield 16, is increased toward the rear of the appliance, to provide a wider trough particularly toward the lingual sides of the tongue and the cheek. A top edge 20 of the outer shield 12 is higher than a top edge 22 of the inner shield 16 defined with response to a surface of the trough 14. The top edge 22 of the inner shield 16, while lower than the top edge 20 of the outer shield 12, extends from the trough 14 to provide a high lingual margin for maintaining the sides of the tongue in a position between opposed top edges of the inner shield. The appliance 10 includes one or more lower lingual tabs 24 that extend from a lower edge of the inner shield 16 to position the mandible in an anterior (forward) position.

As used herein “front” means the portion of the appliance configured to be located at the front teeth. The appliance extends from the front teeth toward the rear teeth and defines a central longitudinal axis extending from the front to the back along a center line.

The outer shield 12 is configured to reduce or prevent the overlapping of canines and laterals, in one embodiment, and in another embodiment, to direct the overlapping and canines in a preferred direction to provide room for later erupting teeth such as second molars. In one embodiment there are no individual sockets in the entire preformed appliance, as well as any individual sockets located distal in the posterior dentition. In one or more embodiments, there is a widening of the appliance, particularly at one or both of the outer shield 12 and at the inner shield 16 that occurs about half way through the canine crown. This widening of the outer and inner shield not only is included for the lower arch, but is also included for application in the upper arch.

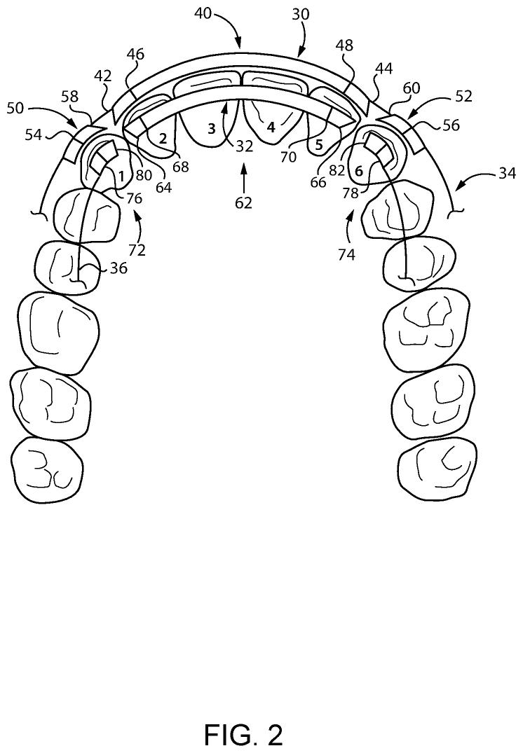

The appliance includes a labial strap 30 that extends along the labial surfaces of the anterior teeth and a lingual strap 32 that extends along the lingual surfaces of anterior teeth, each of which is configured to exert pressure against opposites surfaces of the anterior teeth. The labial strap 30 extends from a surface of the upper shield 12 and the lingual strap 32 extends from a surface of the inner shield 16. Each of the straps 30 and 32 protrudes from its relative surface, for instance surface 34 of the upper shield 12, toward the surfaces of the teeth where the straps 30 and 32 contact the teeth as seen in FIG. 2. Surface 34 of the upper shield 12 is illustrated in FIG. 2 and a surface 36 of the inner shield is also illustrated in FIG. 2.

FIG. 1B a perspective top view of another embodiment of overlapping canines and laterals dentition appliance for an upper (maxillary) arch of an individual. In this embodiment, the appliance 10 includes a ramp 29 coupled to the appliance 10 of the inner shield which is angled to elevate the tongue toward the upper palate. A flexible wire 27 is embedded, in some embodiments, in the inner shield 16. The wire 27 retains its shape when adjusted to modify the width of the appliance 10. By adjusting the width, the width of a person's jaw is also adjusted, wherein the dentist provides the adjustment to arrive at a desired jaw width. In addition, in this embodiment, there are three lingual tabs 24.

FIG. 2 illustrates locations of the straps 30 and 32 with respect to the anterior teeth, here identified as teeth 1 through 6. Teeth 1 and 6 are canine teeth and teeth 2-5 are incisors. Teeth 2 and 5 are lateral incisors and teeth 3 and 4 are central incisors. While FIG. 2 illustrates the maxillary teeth of the upper arch, FIG. 2 applies equally as well to the anterior teeth of the mandibular teeth of the lower arch. The straps 30 and 32 are illustrated without the remaining portions of the appliance 10 of FIG. 2.

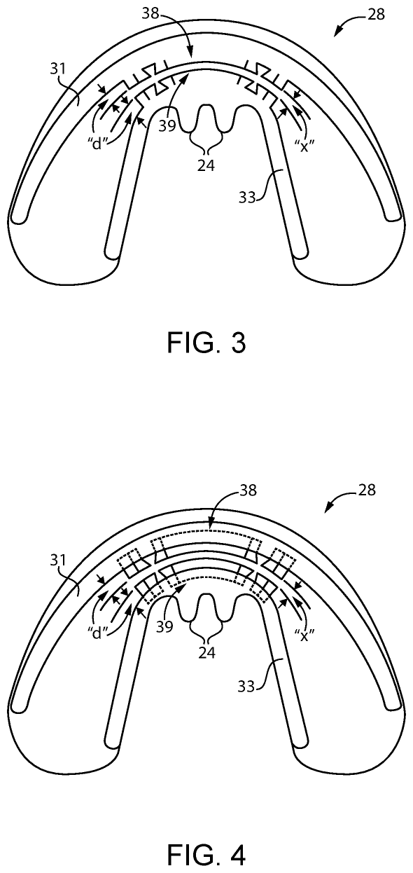

FIG. 3 illustrates a bottom view of a lower jaw appliance 28. The lower jaw appliance 28, in one embodiment, is an individual and unitary appliance that is used by itself. In other embodiments, the upper jaw appliance 10 is connected to the lower jaw appliance 28 and both are used at the same time to move the anterior teeth to positions of preferred, little, or no overlap. The lower jaw appliance includes an outer shield 31 and an inner shield 33. In one embodiment, each of the straps 30 and 32 of the appliance 10 and straps 38 and 39 of the lower appliance 28 are located at the crown of the teeth and at about one-third (⅓) of the distance from the incisal edge toward the gumline. Each of the straps 38 and 39, in one embodiment as illustrated in FIG. 3, extends from an external surface of the respective shields 31 and 33 for a distance of about 0.7 mm. The straps extend towards the tooth surfaces. See distance “d”, for instance in FIG. 3. The distance “d” between straps also applies to the straps 30 and 32 of FIG. 1A. In one embodiment, each of the straps 30 and 32 is formed of the same material at the outer shield 12 and the inner shield 16 in a molding process. See FIG. 3. In another embodiment as seen in FIG. 4 illustrating another embodiment of the lower jaw appliance 28, each of the straps 38 and 39 are separately formed parts that are embedded in the material that forms the outer shield 12 and the inner shield 16. See the dotted lines within each of the shields 31 and 33 that indicate the straps 38 and 39 being partially embedded within the shield. The point at which the straps are first exposed when extending from the surface of the appliance is considered as a base of the straps and the distance of 0.7 mm is the distance from the surface of the appliance to the topmost portion of the straps. The distance of the contacting portion of the straps from the surface of the appliance, however, varies depending on the size of the appliance that has been selected for the patient.

As seen in FIG. 2, the labial strap 30 includes a labial incisal strap 40 that extends from the mesial sides of incisor 2 to incisor 5. The labial incisal strap 40 includes a first terminating end 42 and a second terminating end 44 wherein each of the terminating ends 42 and 44 are sloped respectively toward the distal side of the lateral incisors 2 and 5 and toward the mesial sides of the canines 1 and 6. A slit 46 is located at about a midpoint of the lateral incisor 2 and a slit 48 is located at about a midpoint of the lateral incisor 5. Each of the slits 46 and 48 define a cut that enables the terminating ends 42 and 44 to be separated from the incisal strap 40, while still being in relative contact. In another embodiment, a space existed between the terminating ends and the incisal strap. The labial strap 30 also includes a first labial canine strap 50 located at canine 1 and a second labial canine strap 52 located at canine 6. A slit 54 is located at about a midpoint of the strap 50 and a slit 56 is located at about a midpoint of the strap 52. Each of the canine straps 50 and 52 respectively include terminating ends 58 and 60 which are sloped respectively toward the mesial sides of canines 1 and 6 and the distal sides of the lateral incisors 2 and 5.

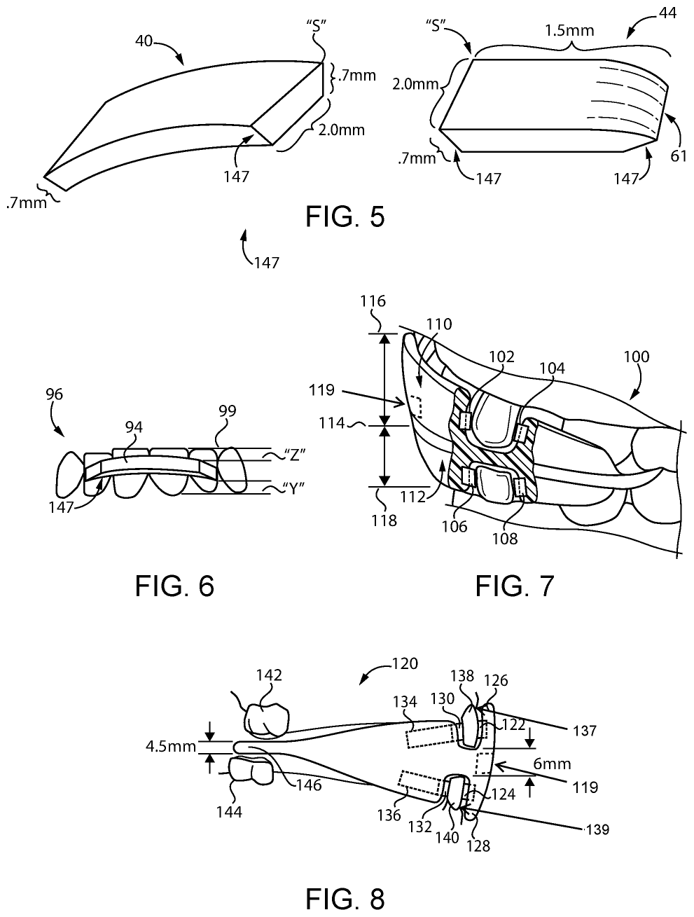

FIG. 5 illustrates an example of one end of the labial strap 30 including a portion of the labial incisor strap 40 and the terminating end 44. In this embodiment, the length of the terminating end is about 1.5 mm. and the height is about 2.0 mm. The width of the portion of the strap extending from the surface of the appliance for both the labial incisor strap 40 and the terminating end 44 is about 0.7 mm. The slit 48, here label as “S” is located between the terminating end 44 and the labial incisor strap 40. In this illustration, the ends of the labial incisor strap 40 and the terminating end 44 have been separated to show lengths, widths, and heights. In the actual embodiments, such as illustrated in FIGS. 3, 4, and 5, the ends are spaced closely together or in contact. An end 61 of the terminating end 44 includes the slope surface as previously described that in this example wedges into the interproximal at the distal of the lateral incisor and the mesial of the canine. The mesial half, i.e. the terminating end 44, buts up against the end of the labial incisor strap 40 which defines the slit 48. In one embodiment, the slit 48 extends completely through the strap 30. In another embodiment, the slit 48 partially extends through the strap 30, with perforations for instance, to maintain the position of the terminating end 44 until being separated from the labial incisor strap. While these dimensions are described with respect to the labial strap 30, these dimensions similarly apply to the lingual strap 32, and the canine straps 50, 52, 72, and 74.

The lingual strap 32 includes a lingual incisal strap 62 that extends from the distal sides of incisor 2 to incisor 5. The lingual incisal strap 62 includes a first terminating end 64 and a second terminating end 66 wherein each of the terminating ends 64 and 66 are sloped respectively toward the distal side of the lateral incisors 2 and 5 and toward the mesial sides of the canines 1 and 6. A slit 68 is located at about a midpoint of the lateral incisor 2 and a slit 70 is located at about a midpoint of the lateral incisor 5. Each of the slits 68 and 70 define a cut that enables the terminating ends 64 and 66 to be separated from the lingual incisal strap 62. The lingual strap 32 also includes a first labial canine strap 72 located at canine 1 and a second labial canine strap 74 located at canine 6. A slit 76 is located at about a midpoint of the strap 72 and a slit 78 is located at about a midpoint of the strap 74. Each of the canine straps 72 and 74 respectively include terminating ends 80 and 82 which are sloped toward the distal sides of the lateral incisors 2 and 5 the mesial sides of canines 1 and 6.

In a completed appliance and before being placed in a patient, the surfaces of the exposed terminating ends, along a lateral direction 89 of the lingual strap and the labial strap are almost in contact. The terminating exposed surfaces of the lingual strap and labial strap include a space therebetween and almost touch each as they approach the tooth surfaces from the lingual and labial directions. In one or more embodiments, the distance “x” between the labial strap to the lingual strap at a contacting location near the incisal edge is 0.1 mm. This distance is located, for instance, at location 90 of FIG. 1A. The distance between the labial strap to the lingual strap increases toward location 92 to about 1.0 mm as this location is further gingivally away from the incisal edge by about 1.5 mm. At this location, the space is 1.0 mm to allow the incisal edges of the incisors to be able to force themselves between these labial and lingual straps of plastic at location 92, when the appliance is initially placed in the mouth. Upon seating of the appliance in the mouth, the straps are positioned about 3 mm from the gingival margin and about 1.5 mm from the incisal edge. Consequently, the straps are located in the appliance at an appropriate location to enable this positioning of straps with respect to an individual's teeth. For instance, as seen in FIG. 6, a labial incisal strap 94 is located at bottom incisors 96 wherein a distance “Y” is about 1.5 mm from an incisal edge 98 and a distance “Z” is about 3 mm from a gingival margin.

FIG. 7 illustrates a portion of dentition appliance 100 for both the upper arch and the lower arch having a cutaway view to show locations of a labial bar 102 and a lingual bar 104 of an upper appliance and a labial bar 106 and a lingual bar 108. As can be seen, the teeth of both the upper arch and the lower arch are captured between the respective labial and lingual bars. The appliance 100 includes an upper shield 110 and a lower shield 112. The upper shield 110 extends from the parting line (middle of appliance, vertically) 114 to a top edge 116 of the appliance a distance of about 17.0 mm of the appliance 100, FIG. 7. The lower shield 112 extends from the parting line 114 to a bottom edge 118 a distance of about 12.0 mm.

The labial strap 30 or the lingual strap 32 from the distal on one canine to the other canine is used for rotations of the incisors if needed, but also, these straps are present to rotate the canines and lateral incisors on each side to force them to be overlapped in the correct direction. The overlapping can be in one direction or the other and is determined by the dentist, the analyzing dentist, or by artificial intelligence of the computer. The direction refers to the direction that a labially rotated lateral or a lingually rotated lateral would be in an either labial or lingual direction. If one side has the canines overlapping the lateral incisor in a certain direction, this would dictate the direction that would be duplicated in the same way on the opposite side. Since the interproximal in the plastic appliance would not be present, this would allow teeth of different widths to be accommodated in the appliance. Two preformed (or custom) appliances of 2 sizes (3.5N and 6N) would also be used as a final finishing appliance to perfect the alignment of all teeth into an ideal intercuspation and occlusion.

In one embodiment, there are multiple separate appliances that correct for overlapping in patients having teeth and jaws of different sizes. For instance, in one embodiment there are two separate appliance sizes that represent at least 11 various sizes of the N series, wherein each of the two separate sizes are configured to accurately fit about five sizes out of the 11 various sizes. Consequently, in one system for correcting overlapping, two sizes are sufficient to provide alignment for a large percentage of patients. Using the inventor's previously described preformed adult dentition appliance, that is available in 13 different sizes, the two differently sized appliances would resemble the 3.5N and the 6N. The 3.5N would work properly to rotate different sizes of teeth represented by the 3N, 2.5N and 2N appliances, while in the opposite direction the 3.5N could provide rotations for the 4N and 4.5N appliances. The other size (6N) could accommodate the 5.5N and 5N and in the opposite direction the 6.5N and 7N.

In another embodiment, if only one size is used, for example a 4.5N, the appliance services 5 different sizes of N appliances on either side of the 4.5N size appliance. While this single size, if used as a single universal size, accommodates many sizes, it may not be sufficient to accommodate patients that would require correction at either end, i.e. the smallest patient and the largest patient, of this particular universal size. Consequently, to increase the compliance for a larger number of patients, two sizes are more appropriate, namely the 3.5N and 6N size appliances. The smallest sizes, 1.5N and 1N are rarely used and patients using those sizes rarely experience crowding of the lateral incisors.

Another embodiment of the appliances with rotation bars could be made in every size of the C, IG, G, N appliances for a more perfect and comfortable fit.

Each ½ (one-half) size of the lower N appliance is 0.8 mm different from the adjacent appliance or 0.4 mm on each size of incisor on the left side and the right side of the midline. With the 3.5N, the 3N appliance would be 0.2 mm narrower and the 2.5N would also be 0.2 mm narrower than the 3N for a total of 0.4 mm. On the larger sizes (4N and 4.5N appliances) the increase would be 0.2 mm for each side increase per incisor. Narrower refers to the distance along the curvature of the arch between the two lower canines.

In a system using a single appliance or two appliances, the strap or bar extends from the distal of one canine to the distal of the other canine. At the distal of the lateral, the strap or bar would terminate with a rather steep incline, i.e. the previously described slope, toward the mesial of the canine. The strap or bar starts again at the mesial of the canine with a steep incline towards the distal of the lateral and ends near the middle of the canine. The slit or cut in the incisal strap and canine strap is located at the center of the lateral incisor and of the center of the canine. When it is desired to rotate the lateral incisor or the canine, in that direction, i.e. the direction for either the labial or lingual rotation of either the lateral or the canine, portions of the incisal strap and the canine strap having a slope are removed. If the lateral is to be moved in a lingual direction, the strap on the lingual distal half of the lateral incisor is removed which allows the lateral to be moved lingually. This removal moves the distal half of the lateral incisor in a lingual direction in order to be overlapped by the canine which is then moved in a labial direction. This is completed by removing the mesial half of the labial mesial half of the labial canine strap. This leaves the lingual mesial strap in place to move the mesial half of the canine labially to overlap the lateral.

This procedure is done in the same way on the opposite side. If it is desired to move the lateral incisors labially and the canines lingually, this procedure is reversed with respect to the description described above. Consequently, the canine mesial is rotated to the lingual with removal of the mesial canine strap on the lingual. The lateral would be moved labially by removing the strap on the labial. The reversed procedure only moves the distal of the lateral incisor and mesial of the canine while being able to rotate all other surfaces of the anterior teeth. If there is no need to overlap the laterals and canines, the appliance can serve as a finishing appliance to correct any minor anterior rotations at the end of treatment or at any time in the future. This serves as the final appliance to perfect the anterior occlusion and intercuspation of the posterior teeth.

Each labial or lingual strap extends from a surface of its respective shield of about 0.7 mm and proceeds from one end to the other end to contact the incisors and canines on the labial and lingual surfaces of the crowns of these teeth for both the 3.5N and 6N appliances. The space between the labial and lingual bars proceeding on the inside of the trough has a space between the two bars of about 0.1-1.0 mm from the incisal area down to the gingival area to allow the incisor edges of the teeth to close into the sockets completely. In different embodiments, these straps or bars have a distance from top to bottom of anywhere from 1 mm to about 3 mm, and in one embodiment 2 mm. The superior (upper) part of the upper straps and the inferior (bottom) part of the lower straps are slightly tapered at sides 147 of FIG. 5 to allow the incisal edges of the teeth to more easily slip into place while occluding the teeth. As described herein, the tapered means that the exposed surface that comes into contact with the teeth is slanted the entire width of the strap and is consequently slanted to prevent the incisal edge of the incoming incisor from catching or being blocked from entering the space between the two straps. This allows the incisor to more easily slip into place.

The space between the labial and lingual surfaces of the upper canines are slightly wider in the center of the canine than at the mesial and distal edges, being about 2-3 mm from the labial to lingual. These bars or straps are positioned at about the upper third of the crown height toward the incisal edge. This is about 1.5 mm from the incisal edge. The bars are 0.7 mm thick labially lingually with about 0.1 mm (incisorly to 1.0 mm gingivally) of space between the labial and lingual bars for the incisal edges to squeeze through.

A freeway space, i.e. space between upper and lower teeth, of the 3.5N appliance having both a combined upper appliance and lower appliance is 3.5 mm in the anterior area, and is 2 mm in the posterior area. This space in other embodiments is increased to 6 mm in the anterior and 4.5 mm in the posterior. The freeway space leaves enough the room at the midline for a hole that is 2-2.5 mm in diameter for the pulsator rod to be inserted. This increase in freeway space in the anterior up to 6 mm while the posterior is 4.5 mm is also present to maintain an overbite correction. The upper and lower shields are both (3.5N and 6N) are 21.5 mm and will be increased to 29 mm in the new design. This helps prevent mouth breathing. The posterior horizontal upper arch is 4 mm wider in the current 3.5N and 6N which will be increased by 2 mm per side in the new design. As seen in FIG. 7, shield height is measured along the lines 116 and 118 extending from the top of shield 110 and the bottom of shield 112.

FIG. 8 is a side view of a portion of a dentition appliance 120 for overbite correction. In the embodiment, the appliance 120 includes slats 122 and 124 located respectively in upper outer shield 126 and lower outer shield 128. Slats 130 and 132 are located respectively in upper inner shield 134 and lower inner shield 136. The top incisors, and in particular the top central incisor 138 and the bottom incisors, an in particular the bottom central incisor 140 contact the through of the appliance 120 before the teeth, i.e. molars 142 and 144, come into contact with a rear portion 146 of the appliance 120. The contact of the incisors with the appliance puts pressure against the upper incisors and little or no pressure on the rear teeth which allows the rear teeth to erupt which decreases overbite. The distance between upper and lower incisors is about 6 mm at the front of the appliance and the distance between upper and lower teeth at the rear of the appliance is about 4.5 mm.

Consequently, in one embodiment as described herein, there are two finishing appliances that are used with patients of different ages and having different sized jaws. When compared to the sizes described above, such sizes can correspond to appliances the 3.5N and 6N. For the 3.5N appliance in different embodiments, the distance across the upper permanent four incisors ranges from 29.4 mm to 30.7 mm, the distance across the lower four permanent incisors ranges from 22.0 mm to 22.7 mm, and the upper permanent 6 anteriors range from 45.5 mm to 46.9 mm. For the 6N appliance in different embodiments, the distance across the upper permanent four incisors ranges from 36.7 mm to 37.8 mm, the distance across the lower four permanent incisors ranges from 26.7 mm to 27.4 mm, and the upper permanent 6 anteriors range from 54.5 mm to 55.9 mm. For the 3.5N appliance in different embodiments, the width across the appliance at the upper first permanent molars is 43.7 mm and the width across the appliance at the lower first permanent molars is 42.6 mm. For the 6N appliance in different embodiments, the width across the appliance at the upper first permanent molars is 48.4 mm and the width across the appliance at the lower first permanent molars is 46.4 mm. For the 3.5N appliance the length of the appliance in one embodiment is 44.7 mm. For the 6N appliance, the length of the appliance in one embodiment is 47.3 mm.

As described herein, in one embodiment of an appliance having labial strap 30 and the lingual strap 32 no individual or extended sockets are included in the trough, and the trough is therefore socketless. The trough on either side of the appliance is extended in some embodiments to encompass lower second permanent molars. In one embodiment, the extension is about 4 mm of the trough at the posterior ends of the trough. In still other embodiments, the lingual tabs 24 include a length of about 8 mm. In other embodiments, the lingual tabs have a length in the range of 4-12 mm. In still other embodiments, one or more appliances include palatal tabs to allow tongue to be expanded to widen the palate. Please see U.S. Pat. No. 10,537,407 describing palatal tabs, the disclosure of which is incorporated by reference.

In summary, one or more embodiments as disclosed herein includes one or more of the following features.
1. All interproximal areas of the 3.5N and 6N are removed, wherein the interproximal areas defined as the plastic portions in a typical appliance that extend between each tooth socket that separated on socket from an adjacent socket.
2. The straps are tapered or slightly slanted on the lower (towards the gingival margin) and toward the gingival margin of the upper straps to facilitate the teeth to more easily insert themselves fully into the appliances.
3. There is a thin slit or cut in the middle of the lateral and canine straps or bars to facilitate the removal of the distal portion of the strap of the lateral and the mesial portion of the strap of the canine.
4. The shields are made higher gingivally between the upper and lower of about 29 mm from the current 21.5 mm in the existing 3.5N and 6N appliances.
5. The freeway space (between upper and lower incisal edges) is increased to 6 mm from the 3.5 mm from present appliance and posteriorly is increased to 4.5 mm from the current 2 mm.
6. The lingual margins in the posterior are elevated to about 16 mm from 6 mm in the 3.5N and to about 18 mm from 9 mm currently in the 6N.
7. The posterior will be texturized to increase the adherence of the reline material to the plastic of the appliance.
8. The anterior strap or bar will go from the distal of one canine to the other canine labially and lingually on the lower and upper arches.
9. The upper half of the appliance may have a ramp to guide the tongue into the palate during resting posture as well as during swallowing.
10. The ends of the straps, labially and lingually, are tapered at the distal (rear end) of the upper and lower laterals and at the mesial (front end) of the canines on the upper and lower straps.
11. Can overlap the canines and laterals both labially or lingually to accommodate crowding.
12. The appliance has a hole in the front midline between the upper and lower teeth for a pulsator rod to be inserted.

As described herein, the overlapping canines and laterals dentition application includes numerous advantages as follows:
1. It is an easy way to obtain rotations with a preformed appliance or appliances with rotation projections molded in place.
2. Can overlap the canines and laterals to accommodate crowding.
3. Eliminates need for placing metal cleats into appliance.
4. Can rotate teeth in either labial or lingual directions.
5. Eliminate need for many sized appliances.
6. Squeezes teeth into a tight fit due to the labial and lingual straps or bars which increase the straightening.
7. Does not have positioner sockets so one size can fit various sizes of teeth.
8. Posterior end of appliance can fit any size of posterior teeth.
9. Is made for overbite retention or correction with more material vertically between the front teeth than vertically between the rear teeth that resists relapse.
10. Can be worn after normal more closely sized appliances after they have finished their straightening.
11. Can be used as a retainer or finishing appliance.
12. Can be used as the main treatment appliance.
13. Rotation, slats or bars can be molded in either the upper or lower arches both labially and lingually to rotate both labially and lingually.
14. Is preformed since one size fits many sizes of teeth and no measurement is needed.
15. There are no sockets so all sizes of teeth can fit into 2 appliances.
16. Can expand upper arch with an imbedded wire.
17. Can advance the mandible to correct abnormal overjets.
18. By having long lingual tabs will help to eliminate abnormal sleep issues by keeping the mandible from slipping posteriorly while sleeping.
19. The appliances are longer to prevent overeruption of the second permanent molars.
20. Have higher posterior buccal and lingual margins so the reline material can go into the interproximal areas for better retention of the appliance.
21. Higher and lower shields to prevent mouth breathing.
22. There is no measuring for a specific appliance size since a single new appliance works for several different sizes of teeth.
23. A pulsator can increase the speed of rotations of the dentition.

While exemplary embodiments incorporating the principles of the present disclosure have been described herein, the present disclosure is not limited to such embodiments. Instead, this application is intended to cover any variations, uses, or adaptations of the disclosure using its general principles. Further, this application is intended to cover such departures from the present disclosure as come within known or customary practice in the art to which this disclosure pertains.

1. A preformed dentition appliance to adjust an alignment of a person's teeth, the teeth including front teeth of upper teeth and front teeth of lower teeth, comprising:
a body including a front portion, a rear portion extending from the front portion, the body defining a central longitudinal axis extending from the front portion to the rear portion, a trough, and an outer shield spaced from an inner shield with the trough disposed therebetween, wherein the outer shield is higher than an upper teeth gumline of the upper teeth and lower than a lower teeth gumline of the lower teeth to prevent mouth breathing and the body includes a first strap extending from the outer shield and a second strap extending from the inner shield to labial and lingual surfaces of the front teeth to rotate the teeth and to overlap canine teeth and lateral teeth in different directions to accommodate adult incisal crowding and to correct tooth rotations in any direction, wherein the first strap includes a substantially smooth surface extending between terminating ends and contacts the incisors and canines on the labial surfaces of the crowns of the incisors and the canines, and the second strap includes a substantially smooth surface extending between terminating ends and contacts the incisors and canines on the lingual surfaces of the crowns of the incisors and canines, and wherein the body includes lower lingual tabs to maintain the lower jaw in a more anterior position to move anterior teeth to positions of preferred, little, or no overlap and to advance a mandible of the person to correct abnormal overjets.

2. The appliance of claim 1 wherein each of the first and second straps extends laterally with respect to the longitudinal axis along a mesial surface of one or more anterior teeth, and each of the substantially smooth surfaces of the first and second straps are uninterrupted by features extending from the substantially smooth surfaces.

3. The appliance of claim 2 wherein the body is formed to align with and engage the lower teeth of the person.

4. The appliance of claim 2 wherein the body is formed to align with and engage the upper teeth of the person.

5. The appliance of claim 2 wherein the first strap and the second strap are molded as a part of the outer shield and the inner shield respectively.

6. The appliance of claim 2 wherein the first strap and the second strap are embedded in the outer shield and the inner shield respectively.

7. The appliance of claim 6 wherein the first strap and the second strap each include a first hardness and each of the outer shield and the inner shield include a second hardness different than the first hardness.

8. The appliance of claim 2 wherein each of the first strap and the second strap are an individual part that is embedded respectively in the outer shield and the inner shield, and wherein the first strap and the second strap include a material that is different than the material of the outer shield and the inner shield.

9. The appliance of claim 2 wherein the first strap includes a first incisal strap and two first canine straps, wherein a first one of the first canine straps is spaced from a first end of the first incisal strap to define a first space and a second one of the first canine straps is spaced from a second end of the first incisal strap to define a second space, wherein the first space defines the lack of an interproximal in the first strap at the first end of the first incisal strap and the second space defines a lack of an interproximal in the first strap at the second end of the first incisal strap, wherein the first space and second space allow teeth of different widths to be accommodated in the appliance.

10. The appliance of claim 9 wherein the second strap includes second incisal strap and two second canine straps, wherein a first one of the second canine straps is spaced from a first end of the second incisal strap to define a first space and a second one of the second canine straps is spaced from a second end of the second incisal strap to define a second space, wherein the first space defines the lack of an interproximal in the second strap at the first end of the second incisal strap and the second space defines a lack of an interproximal in the second strap at the second end of the second incisal strap to allow teeth of different widths to be accommodated in the appliance.

11. The appliance of claim 9 wherein at least one of the first and second incisal straps includes a sloped end, wherein the sloped end is located toward or at separations between a distal surface of one of the anterior teeth and a mesial surface of another of the anterior teeth.

12. The appliance of claim 11 wherein one of the anterior teeth having the distal surface is an incisor tooth and the one of the anterior teeth having the mesial surface is a canine tooth.

13. (canceled)

14. The appliance of claim 11 wherein the one or more of the incisal straps and two canine straps include a slit to enable separation of the sloped end from a remainder of the one or more of the incisal strap and the two canine straps.

15. The appliance of claim 2 wherein the first strap includes a first incisor strap protruding from a surface of the outer shield and the second strap includes a second incisor strap protruding from a surface the inner shield, wherein the first incisor strap and the second incisor strap define a space located between surfaces of the first incisor strap and the second incisor strap, wherein the space is selected based on enabling incisal edges of the incisors to be able to force themselves between the first incisor strap and the second incisor strap.

16. The appliance of claim 15 wherein the space is about 1 mm.

17. The appliance of claim 1 wherein the body includes an upper half wherein an embedded wire is located within the upper half of the appliance.

18. The appliance of claim 1 wherein the body includes a lower half wherein an embedded wire is located within the lower half of the appliance.

19. The appliance of claim 1 wherein the lower lingual tabs extend from a lower half of the appliance.

20. The appliance of claim 18 further comprising a ramp extending from the lower half to encourage the tongue to be positioned within the palate.

21. The appliance of claim 1 further comprising a hole located in the front portion of the appliance to accept a pulsating rod.

22. A method of fitting the preformed dentition appliance of claim 1 to adjust an alignment of a person's teeth comprising:
determining a size of a one of a person's upper arch or lower arch;
selecting from two or more preformed dentition appliances, each of which includes a labial bar extending from a labial shield and a lingual bar extending from a lingual shield, based on the determined size of the person's upper arch or lower arch; and
configuring one or both of the lingual bar or labial bar to rotate one or both of a person's canines or laterals to adjust the alignment of the person's teeth and to rotate the incisors.

23. The method of claim 22 wherein the configuring step includes removing a portion of one or both the lingual bar or the labial bar to rotate one or both of a person's canines or laterals to adjust the alignment of the person's teeth

24. The method of claim 23 wherein the configuring step includes wherein the portion removed of one or both of the lingual bar or labial bar includes a terminating end located toward a distal side of a lateral incisor tooth and a mesial side of a canine tooth.

25. The method of claim 24 wherein the configuring step includes wherein the terminating end is sloped.

26. The method of claim 24 wherein the lower part of the labial and lingual strap is inclined so the lower teeth are not substantially inhibited from ascending fully into the trough.

27. The method of claim 25 wherein in the upper part of the labial and lingual strap is slanted or inclined so the upper teeth are not substantially inhibited from descending fully into the trough.
